(19) United States
(12) Patent Application Publication
(10) Pub. No.: US 2009/0048837 A1
(43) Pub. Date: Feb. 19, 2009

(54) Phonetic tone mark system and method thereof

(76) Inventors: Ling Ju Su, Van Nuys, CA (US); Kuojui Su, Van Nuys, CA (US)

Correspondence Address: Kuojui Su, 13936 Wyandotte St., Van Nuys, CA, 91405, US

(21) Appl. No.: 11/891,740

(22) Filed: Aug. 14, 2007

(51) Int. Cl. G10L 15/04

(52) U.S. Cl. 704/254; 704/E15.005

(57) ABSTRACT

A system and method that utilizes common symbols for marking the tones of alphabet letters of different languages. The marking system and method employs the symbols from the standard English typing keyboard to denote tones. There are seven phonetic tone marks. Each mark represents a unique tone. The system can be applied to any alphabetic writing letters of different languages to denote specific language tones. The method makes it possible for alphabetic writing of any kind of language and for people to effectively capture the tones of words in different languages.

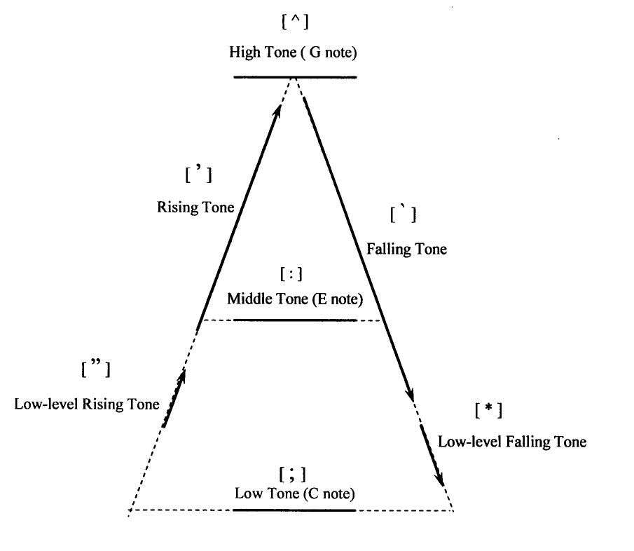

### FIELD OF THE INVENTION

This invention relates to the system and method that utilizes common symbols for marking the tones of alphabet letters of different languages. There are seven tone marks that derive from the symbol keys on the standard English typing keyboard. Each of the seven tone marks represents a predetermined language tone.

### BACKGROUND OF THE INVENTION

There are two popular methods of learning a language. One is through the use of phonetic systems. Another is through the imitation of sounds. As more people have traveled in recent centuries with improvements in the transportation systems and intensified trading activities between countries, it became increasingly common for people to feel the need or desire to learn other languages. Thus phonetic systems used for learning and teaching different languages became widely accepted. Phonetic systems such as the International Phonetic Alphabet System, the Webster's Phonetic System, and The Chinese Pinyin System have become popular in the last two centuries as tools for people to use to learn proper pronunciation of a foreign language.

The International Phonetic Alphabet System and the Webster Phonetic System use accent marks to denote accent syllables in word pronunciations. The Chinese Pinyin System uses tone marks to denote tones of Chinese words. Each system was developed to address the specific needs of the languages they served. European languages, which are multi-syllabic languages, are accent focused and the syllable tones in their words can be sufficiently expressed by the use of accent marks. Monosyllabic languages, such as Chinese, are tone specific and need a specific tone mark to indicate the tone of each word.

From the above analysis one can see that the tone rules are different for the two language systems. With so many different tone rules, learning a new language can be challenging. For this reason, the present invention develops a new phonetic tone system to make it easier for people to learn syllable tones in words of different languages.

### BRIEF SUMMARY OF THE INVENTION

A main object of the present invention is to provide a unified phonetic tone mark system that can be applied to the learning and expressing of different languages. The present invention identifies seven language tones and assigns a mark to each of the tones for expressing the tones in written, typing or other visual presentations. These tones cover the tones exist in the different languages in the world and are labeled as High, Middle, Low, Rising, Falling, Low-level Rising, and Low-level Falling Tones.

The tone mark system of the present invention consists of the following unique elements:
1. All the tone marks derive from the standard English typing key board to make it easy for people to produce them when typing.
2. The tone marks were selected based on their ability to evoke the characteristics of the tones they represent for easy recognition and memorization of the symbols.
3. The tones are compared to musical notes for better understanding of the tones.
4. A triangle phonetic tone diagram is provided to give the learner a clearer concept of the tones.

The greatest similarity between music and language is that they both involve pitches. Therefore, comparing language tones to musical notes is an excellent method of understanding the tones. As part of the instructional method, the High Tone is described as comparable to the G note for their similarity in pitch level. The Low Tone is described as comparable to the C note for the same reason. And the same analogy applies to the other tones. These comparisons are approximate and do not imply that the pitch value of each of the language tones is exactly the same as that of the musical note to which it is compared. However, using the musical notes as analogous counterparts is an effective way of demonstrating what the language tones sound like. In addition, a triangle phonetic tone diagram is provided to serve as a visual aid to the understanding of the tones by placing the tones in a physical order according to the pitch level they belong. The tone with the lowest pitch is placed on the bottom of the triangle while the tone with the highest pitch is placed on the top. At the same time, the slope on each side of the triangle infers to the rising and falling nature of Rising and Falling Tones.

A more complete application of this invention, and other objectives, features, and advantages of this present invention will become apparent from the following detailed description, the accompanying drawing, and the appended claims.

### BRIEF DESCRIPTION OF THE DRAWING

The accompanied FIGURE is a phonetic tone diagram. The language tones are organized into three categories of Flat, Rising, and Falling. The triangular diagram illustrates the characteristics of the tones in the three categories. The Flat Tone Category includes Low, Medium and High tones. They are represented by the horizontal lines on the bottom, in the middle, and on the top of the triangle respectively. The Rising Tone Category includes the High-level and Low-level Rising Tones. They are represented by the lines pointing upward on the left slope of the triangle. The Falling Tone Category includes the High-level and Low-level Falling Tones. They are represented by the lines pointing downward on the right slope of the triangle.

### DETAILED DESCRIPTION OF THE PREFERRED EMBODIMENT

The present invention consists of a unified phonetic tone mark system developed to express language tones in different languages. The phonetic tone marks derive from the keys of the standard English keyboard as to make it easy to reproduce them while typing.

The accompanied FIGURE is a triangular phonetic tone diagram with the marks that represent the different tones appropriately labeled. The tones can be organized into three categories: Flat, Rising, and Falling categories. The Flat Tone Category includes High, Middle, and Low Tones. The Rising Tone Category includes the High-level and Low-level Rising Tones. The Falling Tone Category includes the High-level and Low-level Falling Tones. For the purpose of simplification, the High-Level Rising Tone and High-level Falling Tone are simply called Rising and Falling Tones.

Humans are equipped with capable vocal cords that can produce various sounds and transform them smoothly into various pitch levels. When we speak we are making sounds that are continually changing. The changes in pitch occur naturally due to the mechanics and structure of our vocal cord. A syllable tone is often affected or colored by the tones of its neighboring syllables. This is especially true for many multi-syllabic languages. However, some tones have more noticeable coloration than others. Even in monosyllabic languages where the tone of a word is, in theory, independent from the adjacent words, coloration in tone by adjacent words can still be detected in some instances. In actuality, the so called Flat Tones are not completely flat and the tones in the Rising and Falling Tone Categories do not rise or fall in a linear manner as illustrated by the diagram. If we were to speak in tones that are completely flat or always in a steady pitch progression we would sound more like robots than humans. Since the main purpose of the triangle diagram is to show the general characteristics of the tones in a simplified, easy-to-understand way, the pitch progression of each tone is depicted in the linear fashion for the purpose of providing a clear visual presentation of the characteristics of the tones and their relations to the other tones.

The following is list of the tone marks and their corresponding names. In addition, the tones are compared to the musical notes in the traditional Western scale. The comparisons are close approximations and are meant to provide some idea of what the language tones sound like and their relations to the other language tones. The pitch levels and ranges of the named tones may differ for different people. For example, a man with a low pitch voice may pronounce a Low Tone syllable in a lower pitch than a person with a high pitch voice.

| | |
|---|---|
| High Tone | (G note) |
| Middle Tone | (E note) |
| Low Tone | (C note) |
| Rising Tone | (rising from around E to around G note) |
| Falling Tone | (falling from around G note to around C note) |
| Low-level Rising Tone | (rising from around D note to around E note) |
| Low-level Falling Tone | (falling from around D note to around C note) |

| TONE NAME | TONE MARK | APPLICATION EXAMPLE |
|---|---|---|
| 1. High Tone | \hat{ } | Ma\hat{ } ( [symbol] in Mandarin means “mother”) |
| | | Pe\hat{ }ter (Peter) |
| 2. Middle Tone | : | Mee: ( [symbol] in Chinese Min-Nan dialect |
| | | means “noodle”) |
| 3. Low Tone | ; | Ma; ( [symbol] in Mandarin means “horse”) |
| | | U;niversal (universal) |
| 4. Rising Tone | ’ | Ma’ ( [symbol] in Mandarin means “numb”) |
| | | (this tone is similar to the tone one uses when |
| | | uttering the word “yes?” in a questioning |
| | | manner.) |
| 5. Falling Tone | \grave{ } | Ma\grave{ } ( [symbol] in Chinese Mandarin means “scold”) |
| | | Tea\grave{ } (tea) |
| 6. Low-Level Rising Tone | ” | Dae” ( [symbol] in Chinese Min-Nan dialect means |
| | | “tea”) |
| 7. Low-Level Falling Tone | * | De* ( [symbol] in Chinese Mandarin means “of”) |
| | | a*go (ago) |

The first tone in the system is called a “High Tone” and is represented by the mark [̂]. The syllable of [Pê] in “Peter” is an example of High Tone. In Mandarin, the word [mâ] [symbol] , which means “mother”, is an example of High Tone. This tone is named High Tone because the tone is higher than the other tones. For instructional purposes, the High Tone is comparable to the G note in the Western seven-note musical scale.

The second tone is called a “Middle Tone” and is represented by the mark [:]. This tone is often found in Asian or Asian Pacific Island languages. An example of the Middle Tone is the word [mee:] [symbol] which means “noodle” in the Chinese Min-Nan dialect. This tone is comparable to the E note.

The third tone is called a “Low Tone” and is represented by the mark [;]. The syllable [late;] in “emulate” is a close example of what a Low Tone is. In Mandarin, the word [ma;] [symbol] which means “horse”, is another example of the Low Tone. This tone is the lowest compared to the other tones. The Low Tone is comparable to the C note.

The fourth tone is called a “Rising Tone” and is represented by the mark [']The tone of the word “yes?” when uttered in a questioning manner is a Rising Tone. In Mandarin, the tone for the word [ma'] [symbol] which means “numb”, is a Rising Tone. This rises from around the E note to the around G note.

The fifth tone is called a “Falling Tone” and is represented by the mark [′]Single syllable words such as “go”, “tea”, “eat”, when pronounced alone, are pronounced in the Falling Tone. The word [ma′] [symbol] which means “to scold” in Mandarin is another example of a Falling Tone. This tone has a falling quality and hence the name Falling Tone. This tone falls from around the G note to around the C note.

The sixth tone is called a “Low-level Rising Tone” and is represented by the mark [”]. This tone possesses a rising quality less intense than that of the Rising Tone. The Low-level Rising Tone rises from around the D note to around the E note.

The seventh tone is called a “Low-level Falling Tone” and is represented the mark [*]. This tone has a slight falling quality and is often associated with unstressed syllables in English. A close example of the Low-Level Falling Tone is the syllable [a] in “ago”. The tone for the Mandarin word [de* [symbol] , meaning “of”, is a Low-Level Falling Tone. This tone falls from around D note to around C note.

The seven phonetic tone marks are represented by seven common symbols from the standard English typing keyboard. They are easy to produce when typing simply by pressing the keys on the keyboard representing the marks. The marks produced by the said keys can appear in various related typefaces or font styles without their meanings affected.

Some phonetic systems, such as the Chinese Pinyin System, consist of tone marks that cannot easily be produced using a standard typing keyboard. The tone marks of the Chinese Pinyin System are very different from any of the symbols found on the keyboard and therefore can not be produced by simply pressing a key on the keyboard. Methods have been developed to address this problem. For example, in Hong Kong where the main spoken language, Cantonese, has seven tones, the tones are expressed by number letters from 1 through 7 as in ma1, ma2, ma3, ma4, ma5, ma6, ma7 or by alphabet letters as in ma-a, ma-b, ma-c, ma-d, ma-e, ma-f, ma-g. However, these tone marks are very nondescript, which makes it difficult for users to remember which alphabets or letters are associated with which tones.

The present invention identifies the tones that are present in the spoken language and assigns a specific mark to each of the tones. The marks used in the present invention have been selected based on their ability to evoke the characteristics of the tones they represent. The following is a list describing the character and function of each of the tone marks of the present invention.

| Mark | Name | Mnemonic Function |
|---|---|---|
| \hat{ } | High Tone | The mark resembles the peak of a mountain and refers to the fact that |
| | | the High Tone is higher in pitch than other tones. |
| : | Middle tone | The mark consists of two dots and refers to the Middle Tone |
| | | as being neither high nor low but in the middle of the tone range. |
| ; | Low Tone | The mark refers to the fact that the Low Tone is lower in |
| | | pitch than the other tones, as suggested by the comma in the lower |
| | | position of the mark. |
| ’ | Rising Tone | The mark refers to the Rising Tone by the replacement of |
| | | the comma from a low position to a high position. |
| \grave{ } | Falling Tone | The mark suggests a downward movement along a slope. |
| ” | Low-level | The mark suggests that the tone is a member of the Rising |
| | Rising Tone | Tone family. This symbol is a double Rising Tone Mark. |
| * | Low-level | The mark suggests the soft glow of a dimming light or star. |
| | Falling Tone | This tone is often associated with unstressed syllables. |

In comparing the tone mark system of the present invention to the other systems mentioned previously, the present invention is a more effective system for use in learning and expressing language tones. For one thing, these tone marks can be produced easily by directly pressing the appropriate keys on a standard typing keyboard. Another reason is that these marks are easy to remember for they have been carefully selected based on their resemblance or ability to evoke the characteristics of the tones they represent. Furthermore, the selected marks are different from the common number or alphabet letters as to avoid any confusion when in use with alphabet letters to form writing. The unique and innovative design of the present invention makes it easy to use and is an ideal tool for learning and expressing a language.

Many Asian languages consist of monosyllabic words. Many of the words of the same spelling have different meanings when pronounced with different tones. For example, in Chinese Mandarin, the words [mâ] and [ma;] have the same spelling with different tones. The word [mâ] [symbol] with a High Tone means “mother”. The word [ma;] with a Low Tone means “horse”. It is very important for one to differentiate between the different tones to understand or express the correct meanings. A large portion of the Chinese vocabulary contains compound words composed of two monosyllabic words to form a phrase word. For example, yio'yong; [symbol] which in Mandarin means “swimming”, is a compound word composed of two monosyllabic words. When pronounced with different tones, such as in yio;yong′ [symbol] , the compound word becomes a different word meaning “useful”. Without the tone marks, it's virtually impossible for a person who speaks Chinese to know which compound word is really being conveyed. With the tone marks added, people are able to understand the exact pronunciation and figure out which Chinese character words the spelt words represent. The same also applies to how the computer transliterates alphabet letters into Chinese characters. The computer will be able to transliterate more accurately the words expressed in alphabet letters into the appropriate Chinese characters when tone marks are added. Below is an example of a sentence composed of Mandarin words in alphabet writing letters combined with tone marks of the present invention.
wuo; xee;huan̂ yio' yiong; jee' kan′ dien′ying; [symbol] [symbol]
I like swimming and watching movies.

Unlike many Asian languages, European languages belong to the multi-syllabic language system which consists of languages that have multi-syllabic words. Syllable tones in words of multi-syllabic languages are largely dictated by where the accent syllables are and the mood in which the words are expressed. Nevertheless, there still exist certain predictable syllable tone patterns in multi-syllabic languages. Usually the primary accent syllable is a Falling Tone when not being colored by a following syllable, for example, “tea” [tea′] or “ny” in “deny” [deny′]. If the primary accent syllable is colored by a following syllable, then the primary accent syllable is pronounced with a High Tone as in the examples of [tea] in “tearoom” [teâroom] or [cent] in “center” [cent̂er]. In many cases, words consisting of more than three syllables may also have a secondary accent syllable. The secondary accent syllable is pronounced with a Low Tone as in the example of [late;] in “percolate”. In summary, the general tone rules for the English words are that the primary accent syllable is either in High Tone or Falling Tone; the secondary accent syllable, when exits, is pronounced with a Low Tone; syllables that are neither primary nor secondary syllables (non-accent syllables) are generally pronounced with a Low-level Falling Tone.

Followings are examples of the tone marks of the present invention used on English words to indicate accent syllable tones which demonstrate how the tone marks are applied to express syllable tones of a multi-syllabic language. In these examples, the primary accent syllable is indicated either by a High Tone Mark or a Falling Tone Mark depending on the placement of the primary accent. The secondary accent syllable is indicated by a Low Tone Mark. For simplification, the Low-level Falling Tone mark for non-accent syllables is eliminated. The tone marks are placed after the syllables with which they are associated.

| | |
|---|---|
| New Tone Mark System | Accent Mark System (Webster's) |
| cen\hat{ }ter | cen\acute{ }ter |
| deny\grave{ } | deny\acute{ } |
| po\hat{ }pular | pop\acute{ }ular |
| cho\hat{ }colate | cho\acute{ }colate |
| per\hat{ }collate; | per\acute{ }colate\acute{ }\acute{ } |
| Feb\hat{ }ruar;y | Feb\acute{ }ruar\acute{ }\acute{ }y |
| reces\hat{ }sive | reces\acute{ }sive |
| conten\hat{ }der | conten\acute{ }der |
| mo;difica\hat{ }tion | mo\acute{ }\acute{ }difica\acute{ }tion |
| inves;tiga\hat{ }tion | inves\acute{ }\acute{ }tiga\acute{ }tion |
| u;niver\hat{ }sal | u\acute{ }\acute{ }niver\acute{ }sal |
| demor\hat{ }alize; | demor\acute{ }alize\acute{ }\acute{ } |
| in;compat;ibil\hat{ }ity | in\acute{ }\acute{ }compat\acute{ }\acute{ }ibil\acute{ }ity |

The syllable tones in English words may change depending on the neighboring words. For example, the words “social worker”, when pronounced together as a phrase, the primary accent syllable in the first word “social” doesn't change, but the primary accent syllable in the second word “worker” becomes a secondary accent. Many non-native English speakers do not realize this and pronounce the words together with the primary accent placed on the first syllable of each of the words and pronounce both first syllables with a High Tone. The present invention uses the tone marks to address this problem by way of expressing the syllable tones as [sôcial work;er]. This will help the English learner speak English with better accents by putting the correct accents on the correct syllables and pronounce the syllables with the correct tones.

Chinese and English languages are two of the most widely used languages in the world. For this reason, the two languages are used here respectively as an example of monosyllabic and multi-syllabic language. This does not mean, however, that the present invention is only applicable to Chinese or English. We hope the present invention will emerge as a unified tone mark system that can be used throughout the world and be applied to any alphabetic writing language. In addition to its utilization as a learning tool, the tone mark system can be a useful tool for recording languages that are disappearing. Another important function of the present invention in this age of computer technology is that it enables easy use of alphabetic writing letters to express languages that are not normally expressed by alphabets. In the case of using alphabet letters to express Chinese characters, a software program can be created incorporating the tone mark system of the present invention to produce Chinese characters more easily by adopting existing keys from the keyboard as tone marks. Together with the unique combinations of letters and the tone marks, the software is able to transliterate accurately the combination units into appropriate Chinese characters.

The new invention provides a unified phonetic tone system that can be used to indicate the tones of words of different languages throughout the world. On a practical level, the present invention serves as a useful and effective tool for learning and recording languages. On a social and cultural level, making easy the learning of different languages promotes understanding and exchange of ideas from different cultures which further advances progress in our society. The embodiments of the invention should not be limited to these preferred embodiments. Its embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A phonetic system for expressing tones of words in alphabetic writing letters of different languages, used for teaching, reading, writing, transliteration, wherein said phonetic system comprises:
providing a plurality of tone marks, wherein each of said tone marks represents a predetermined language tone;
providing a plurality of tone names, wherein each of said tone name is associated with a said tone mark;
systematically arranging said plurality of said tone marks for allowing systematic understanding of said language tones;
wherein each of said plurality of tone marks is placed at the end of a plurality of alphabet writing syllables, wherein each of said tone mark expresses the tone of said syllable;
wherein each of said tone marks when combined with a said syllabic writing syllable forms a complete syllabic writing unit;
providing a phonetic tone diagram including said tone marks, wherein each of said tone marks is arranged systematically according to its pitch level and pitch progression.

2. The system, as recited in claim 1, wherein a first-language-speaking second language learner chooses a plurality of equivalent tone marks from said first-language, wherein each of said equivalent tone marks represents an equivalent language tone in said second language.

3. The system, as recited in claim 2, wherein each of said tone mark is contributed by a simple popular symbol of the standard English typing keyboard, wherein said phonetic tone marks include [̂], [:], [;],['], [′], [”], [*] and all existing typefaces and fonts associated with said marks.

4. The system, as recited in claim 3, wherein each of said tone mark is attributed with a specific name including the name [High Tone] represented by the [̂] mark, the name [Middle Tone] represented by the [:] mark, the name [Low Tone] represented by the [;] mark, the name [Rising Tone] represented by the ['] mark, the name [Falling Tone] represented by the [′] mark, the name [Low-level Rising Tone] represented by the mark [”], the name [Low-level Falling Tone] represented by the [*] mark.

5. The system, as recited in claim 4, wherein said tone marks include a [̂] mark representing the tone of [Pe] in “Peter”, a [:] mark representing the tone of [symbol] [mee:] in Chinese Min-Nan dialect [symbol] means noodle). a [;] mark representing the tone of “late” in “percolate”, a ['] mark representing the tone of “yes?” in questioning manner, a [′] mark representing the tone of “ny” in “deny”, a [”] mark representing the tone of [symbol] [dae”] in Chinese Min-Nan dialect [symbol] means tea), a [*] mark representing the tone of “a” in “ago”.

6. The system, as recited in claim 1, wherein a said complete alphabet writing unit is transliterated into a logogram by way of software or any computer technologies designed for such purpose.

7. The system, as recited in claim 1, wherein said phonetic system is applicable to various medium.

8. The phonetic system, as recited in claim 5, wherein said language tones are organized into three categories of Flat Tone, Rising Tone and Falling Tone, wherein said Flat Tone Category comprises of High Tone, Middle Tone and, Low Tone; said Rising Tone Category comprises of Rising Tone, and Low-level Rising Tone; said Falling Tone Category comprises of Falling Tone, and Low-level Falling Tone.

9. The system, as recited in claim 1, wherein a phonetic tone diagram including a triangle is provided to give a visual illustration of the characteristics of said tones, wherein the left slope represents said Raising and Low-level Raising Tones, the right slope represents said Falling and Low-level Falling Tones, the flat lines at the base, in the middle and on the top of said triangle represent respectively Low, Middle, and High Tones

10. A method for expressing tones of words in alphabetic writing letters of different languages, used for teaching, reading, writing, transliteration, comprising the steps:
(a) providing a plurality of tone marks, wherein each of said tone marks represents a predetermined language tone;
(b) systematically arranging said plurality of said mark tones into a phonetic tone diagram for allowing systematic understanding of said language tones; and
wherein said step (a) further comprises the sub-steps of:
(a.1) placing said plurality of said tone marks at the end of a plurality of alphabet writing syllables, wherein each of said tone mark expresses the tone of said syllable;
(a.2) placing said plurality of said tone marks at the end of a plurality of alphabet writing syllables, wherein each of said tone mark when combined with a said syllabic writing syllable forms a complete syllabic writing unit;
wherein said step (b) further comprises the sub-steps of:
(b.1) systematically arranging said plurality of said tone marks into a tone diagram according to the pitch level and pitch progression of each of said tone marks.

11. The method, as recited in claim 10, wherein a first-language-speaking second language learner chooses a plurality of equivalent tone marks from said first-language, wherein each of said equivalent tone marks represents an equivalent language tone in said second language.

12. The method, as recited in claim 10, wherein each of said tone mark is contributed by a simple popular symbol of the standard English typing keyboard, wherein said phonetic tone marks include [̂], [:], [;], ['], [′], [”], [*] and all existing typefaces and fonts associated with said marks.

13. The method, as recited in claim 10, wherein each of said tone mark is attributed with a specific name including the name [High Tone] represented by the [̂] mark, the name [Middle Tone] represented by the [:] mark, the name [Low Tone] represented the [;] mark, the name [Rising Tone] represented by the ['] mark, the name [Falling Tone] represented by the [′] mark, the name [Low-level Rising Tone] represented the mark [”], the name [Low-level Falling Tone] represented by the [*] mark.

14. The method, as recited in claim 13, wherein said tone marks include a [̂] mark representing the tone of [Pe] in “Peter”, a [:] mark representing the tone of [symbol] [mee:] in Chinese Min-Nan dialect [symbol] means “noodle”), a [;] mark representing the tone of “late” in percolate, a ['] symbol representing the tone of “yes?” in questioning manner, a [′] mark representing the tone of [ny] in “deny”, a [”] mark representing the tone of [symbol] [dae”] in Chinese Min-Nan dialect [symbol] “tea”), a [*] mark representing the tone of “a” in “ago”.

15. The method, as recited in claim 10, wherein a said complete alphabet writing unit is transliterated into a logogram by way of software or any computer technologies designed for such purposes.

16. The method, as recited in claim 10, wherein said phonetic method is applicable to various medium.

17. The method, as recited in claim 10, wherein said tone diagram further comprising:
a triangle illustrating said language tones, wherein said tones are organized into three categories of Flat, Rising, and Falling;
wherein said Flat Tone Category including said Low, Medium and High tones, wherein said tones are represented by the horizontal lines on the bottom, in the middle, and on the top of said triangle respectively;
wherein said Rising Tone Category including said Rising and Low-level Rising Tones, wherein said tones are represented by lines pointing upward on the left slope of said triangle.
wherein said Falling Tone Category including said Falling and Low-level Falling Tones, wherein said tones are represented by lines pointing downward on the right slope of said triangle.
